(19) United States
(12) Patent Application Publication
(10) Pub. No.: US 2019/0063401 A1
(43) Pub. Date: Feb. 28, 2019

(54) VARIABLE TILTING BLADE TWIN TURBINE WIND MILL

(71) Applicant: DAMODARAN ETHIRAJULU, T.Nagar, Chennai (IN)

(72) Inventor: DAMODARAN ETHIRAJULU, T.Nagar, Chennai (IN)

(21) Appl. No.: 15/515,599

(22) PCT Filed: Jun. 8, 2016
(86) PCT No.: PCT/IN2016/000149

§ 371 Date: Apr. 3, 2017

(30) Foreign Application Priority Data
Apr. 15, 2016 (IN) 201641013184

(51) Int. Cl. F03D 3/06; F03D 3/00; F03D 3/02

(52) U.S. Cl. CPC F03D 3/067; F03D 3/002; F05B 2260/74; F05B 2260/50; F03D 3/02

(57) ABSTRACT

A horizontal axis with two wind turbines, one at each end with a generator or alternator in between, generates electricity driven by wind force. The turbine blades which are flat broadand long, unlike the existing fixed blades, are unique as they change their orientation from knife to blade and then blade to knife while rotating, eliminating wind drag and ensuring free flow of wind and smooth rotation of the turbine, leading to increased conversion of the wind energy into electrical energy. This novel design can be used for replacing all the existing and operating windmills all over the world by upgrading to the twin turbine tilting design leading to many-fold increase in the operating efficiency and power generation at minimal cost. With this design, new rooftop, commercial and industrial grade windmills can be fabricated offering eco-friendly, efficient and cost effective power generating systems.

### BACKGROUND

For the last so many years, windmills operating all over the world are designed using fixed blade turbines. Further, to increase the torque, long narrow blades with bulge at the bottom have been used. Wind drag and consequent reduction in conversion efficiency have been the in-built disadvantages of these designs.

Mr. Albert Betz, the pioneer in fluid dynamics has declared that at any given time, a maximum of 59% of the wind energy can be converted into kinetic energy on the basis of fluid dynamics. But, till date, because of the above stated drag factor, all the current wind mills are able to harvest only 30 to 35% of the wind energy and convert it into electrical energy.

To get over these drawbacks, attempts were made in horizontal axis designs, to increase the efficiency by designing various modifications to the blades or providing unimaginably long blades or with a folded leaf like blade with a slight curve at their tip. Only very marginal improvements could be achieved due to these changes. Thus the largest windmill weighing around 3500 tons could produce only 8 megawatts of power so far.

In the vertical axis designs, attempts were made to alter the orientations of the blade and frame structures but could not achieve any major improvement. Thus, till date, the horizontal axis windmills are the widely prevalent power producing windmills throughout the world.

To ensure free uninterrupted flow of wind, the windmills are also being located in the mid-seas but with very limited further improvements in power generation.

### SUMMARY OF THE PRESENT INVENTION

To overcome the above stated deficiencies in the current designs of windmills, it is now being proposed to make use of a horizontal axis with two wind turbines one at each end with an alternator in-between. The turbine blades are designed to change their orientation from knife to blade and then blade to knife while rotating, eliminating wind drag and ensuring free flow of wind and smooth rotation leading to increased conversion of the wind energy into electrical energy. Unlike the existing fixed blades, they are unique in design being flat, broad and long.

This novel design can be used for replacing all the existing and operating windmills all over the world by upgrading to the twin turbine tilting design leading to multiple fold increase in the operating efficiency and power generation at minimal cost.

Thus, as incorporated in this invention, the turbine blade travels along with the wind being pushed by it, with the blade side facing the wind along its upper semi-circular trajectory (half way mark of a circle) till it reaches the opposite end. In other words, for the upper 180 degrees travel of its circular orbit, it functions as a blade.

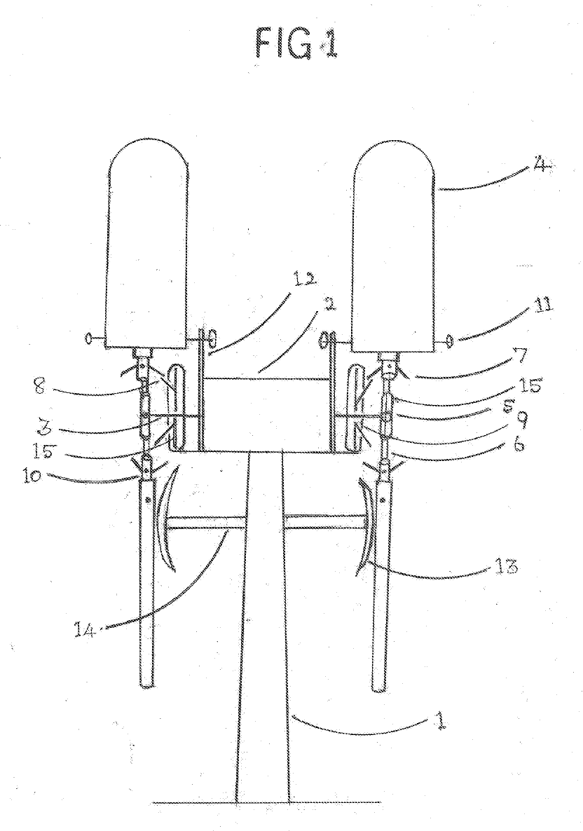

In FIG. 1, the above embodiment is shown pictorially as an erected windmill tower. The mill tower (1) consists of nacelles (2), horizontal shaft (3), blades (4), central hub (5), blade shaft (6), blade handle knob (7), guide ring lever (8), guide ring (9), blade handle (10), blade direction stabilizer (11), upper circular guide ring (12), lower guide ring plate (13), lower guide ring supporting rod (14) and inner guide ring (15).

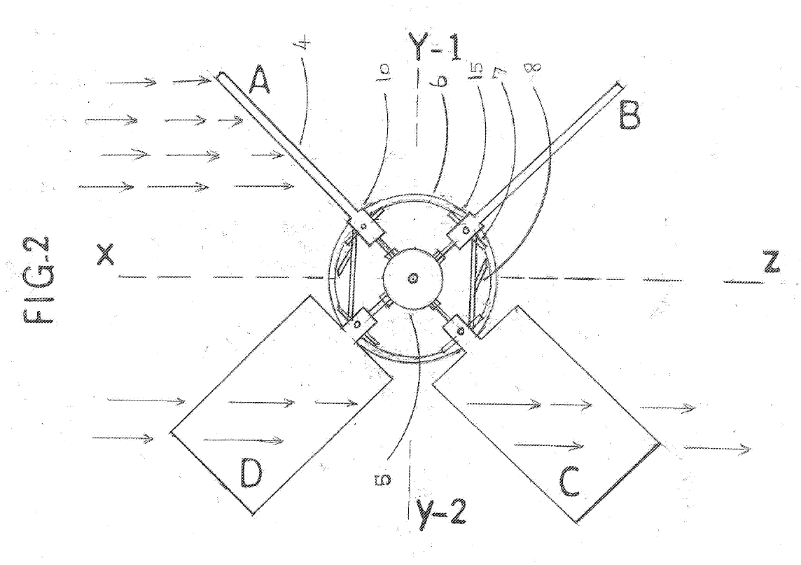

FIG. 2 shows the part of the windmill as a side view showing the blades (4), the central hub (5) inner guide ring (15) and blade handle (10) two of them with blade orientation and the remaining two with knife orientation.

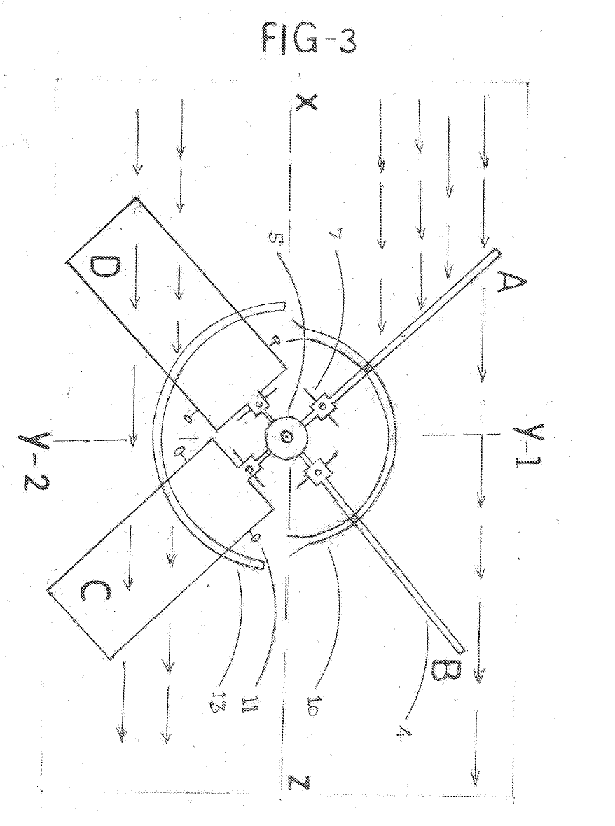

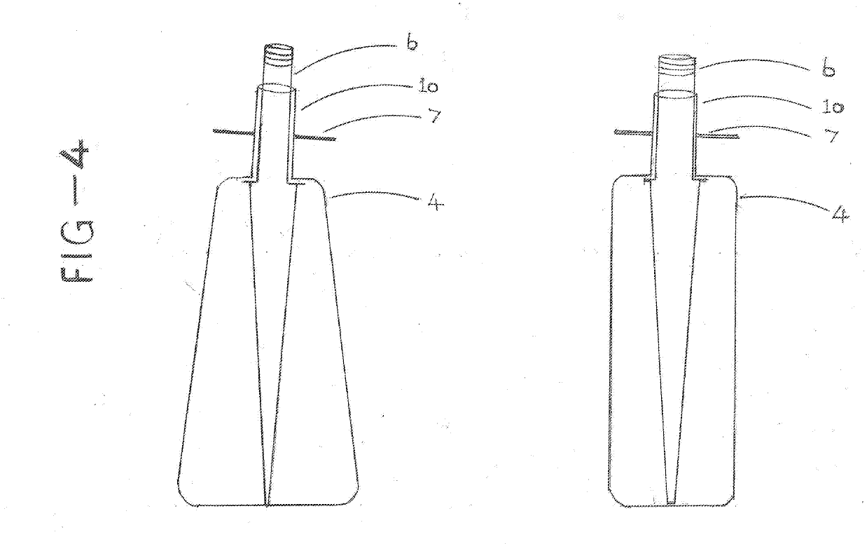

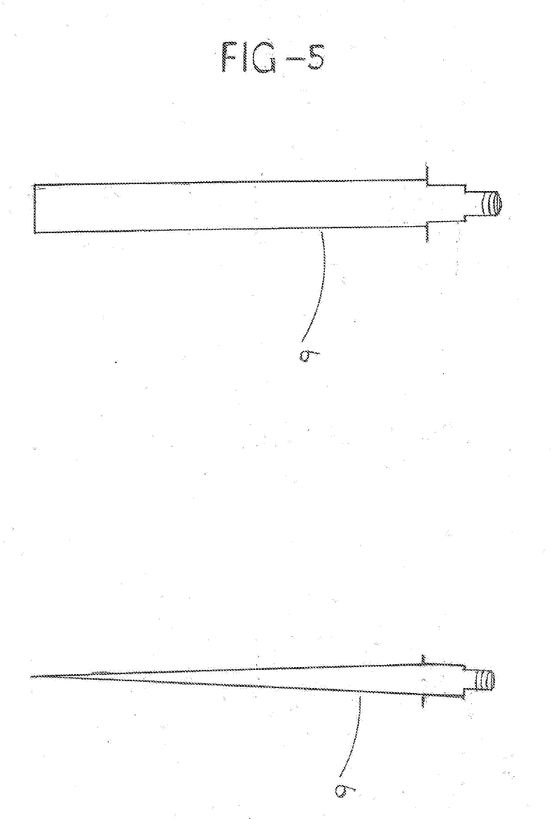

FIG. 3 shows the blade (4), blade handle (10), upper circular guide ring (12), lower guide ring plate (13), blade handle knob (7), blade direction stabilizer (11) and central hub (5).

FIGS. 2 and 3 also show the functioning of the tilting blades (4) and central hub (5), as side view, starting from point X which is at 0 degree on the horizontal line to point Z which is at 180 degrees, the blade travels upwards pushed by the wind. On reaching point Z, it tilts and varies its orientation into a knife form and continues its travel for the remaining 180 degrees of lower half of the circular orbit, piercing through the wind eliminating wind drag and resistance.

Operating Mechanism of this Design:

As given in FIGS. 2 and 3, when wind hits the blade A at point Y-1 facing it, the turbine starts moving whereby subsequent blade D which is near point X shifts its orientation from the knife mode to the blade mode, aided by the blade handle knob being pushed down by the guide ring's first lever which ensures the tilt and starts climbing up.

During this process when blade B in the blade mode which is close to point Z, gets its handle knob pushed upwards by the guide ring's second lever making it to change its orientation from blade to knife and travels downwards along the bottom semicircle till it reaches point X, crossing point Y-2.

When this happens, blade C which is in knife orientation near the point Y-2, travels upwards as such till it reaches point X and shifts its orientation from knife to blade mode aided by its blade I

The simultaneous changing of the orientations of the four blades from blade mode to knife mode and knife mode to blade mode with the aid of the wind thrust is achieved by the unique design of blade handle knob which is further described below.

The inner constituents of blade handle knob (7) are unique. When it moves upwards it gets pushed down by the inner ring lever (8). Both the knob and the lever are placed at an angle of 45 degrees and when one meets the other, the resultant tilt will be 90 degrees whereby the blade's orientation is shifted from blade mode to knife mode and vice versa. The same blade when it reaches point Z, the consecutive knob gets pushed up by the inner ring second lever, thus the continuous tilting-variation of the blade's orientation is achieved leading to the maximization of the torque and power generation.

The shaft of the blades are uniquely designed whereby the blade is securely fastened to the blade shaft (6) by its reduced handle cum neck and sealed with a cup and locked with provision of a hole in the middle for facilitating easy rotation of the blade alone. This narrow neck prevents the blade from sliding out of the shaft in its downward travel. The shaft is firmly secured to the hub by means techniques well known to the art.

Wind being known for its varying speed and direction, would make the blades to wobble in their circular orbits in both the orientations. Safeguards should therefore be made at all times to arrest this. To achieve this, a round metal plate is attached to the side of the blade perpendicular to it to function as blade direction stabilizer (11). When the blade is in its upper orbit, this component travels inside the upper circular guide ring (12) preventing the wobbling of the blades. Likewise, a flat semicircular lower guide ring plate (13) fixed to the windmill's tower with props prevents the blades' wobbling in its lower orbit.

To eliminate friction, noise and loss of torque, the knobs, levers, guide plates and guide rings are lined with suitable friction eliminating materials.

At times of emergency, when the turbine needs to be halted, a design provision is made to withdraw the guide ring thrust levers whereby the blades' orientation as knife is prolonged, leading to halting of the turbine

1. A wind generator turbine with horizontal axis incorporating tilting-varying blade comprising of
a) A shaft securely fastened to the turbine hub attached with a tilting-varying blade,
b) Where the position of the shaft is fixed while the attached blade alone revolves around it changing its orientation from the knife mode to blade mode and vice versa.
c) Where the blade is securely fastened to the shaft by its reduced handle cum neck and sealed with a cup and locked with provision of a hole in the middle for facilitating easy rotation of the blade alone.
d) Where the blade's varying orientation is achieved by a set of knobs, mounted on the blade's handle at an angle of 90 degrees apart plus 45 degrees in variance to the alignment of the blade's edges, aided by the guide ring levers.
e) Where one knob of the blade handle in association with the guide ring+s first lever enables the tilting of the blade's orientation from knife to blade mode.
f) Where the blade's consecutive knob coupled with the blade ring's second lever enables the tilting of the blade from the blade to the knife mode.
g) Where the blade direction stabilizer with the aid of upper circular guide ring ensures the smooth rotation of the turbine without being disturbed by the changing wind, course and direction preventing the resultant wobbling.
h) Where the lower flat plate ring likewise prevents the wobbling of the blade while it is in its lower orbit of rotation.

2. The windmill turbine of claim 1, where-in the shape of the blade is designed in a rectangular, flat and broad manner for harvesting maximum wind thrust leading to increased power generation.

3. The windmill turbine of claim 1, wherein the design of the tilting—varying blade turbine mounted at one end of the shaft by its sideways circular movement facilitates mounting of one more turbine at the other end of the same shaft resulting in doubling of the torque leading to increased power generation.

4. The windmill turbine of claim 1, wherein the number of blades can be increased to any optimum number to reap the uninterrupted harvesting of the wind thrust leading to maximization of power generation, by a slight change in the shape of blades.

5. The windmill turbine of claim 1, wherein by replacing the mechanical guiding levers with electronic Wi-Fi technique geared motor, the blade's orientation from blade to knife and vice-versa could be achieved leading to friction free synchronized rotation of the turbine.
